(19) United States
(12) Patent Application Publication
(10) Pub. No.: US 2009/0144394 A1
(43) Pub. Date: Jun. 4, 2009

(54) METHOD OF PREPARING AND DISTRIBUTING BOARD PAPERS

(76) Inventors: Alastair Mark Percival, Christchurch (NZ); Christopher Roderick McLeod, Christchurch (NZ); Brian Peter Henry, Sag Harbor, NY (US); Alessandro Sodi, Manhasset, NY (US); Robert Howard Craig, Asheboro, NC (US)

Correspondence Address: JOHN ALEXANDER GALBREATH, 2516 CHESTNUT WOODS CT, REISTERSTOWN, MD, 21136, US

(21) Appl. No.: 12/326,288

(22) Filed: Dec. 2, 2008

(30) Foreign Application Priority Data
Dec. 3, 2007 (NZ) 563964

(51) Int. Cl. G06F 15/173

(52) U.S. Cl. 709/218

(57) ABSTRACT

A management system including a conversion system, a central system and one or more access points connected to the central system by a network; wherein said conversion system includes a scanning device and file conversion means configured to take a physical or electronic board paper and convert it to a digital document; the central system includes one or more accounts and one or more databases, such that the or each digital document is collated into one or more board books which are electronically stored in the or each database, the or each account is associated with a designated director who wishes to access the or each board book; said central system is configured to control access to the or each board book by the or each director.

### FIELD OF THE INVENTION

The present invention is a method of preparing and distributing board papers for electronic distribution.

### BACKGROUND

Directors on the boards of companies are required to consider and vote on various proposals; these proposals are normally presented in the form of documents called board papers. These papers are traditionally printed, collated and sent out to the directors some time before a meeting is convened to vote on the various board papers. The collated board papers are called board books and these may contain many tens or even hundreds of individual board papers.

The confidentiality of the board papers and the effect they can have on customers and the public's perception of the company concerned means they have to be carefully protected. The distribution of the board papers requires care so that this confidentiality is maintained. With many directors now members of more than one board and travel being both easier and cheaper getting board documents to a director can be difficult and/or expensive. For example how can a courier be certain that the person accepting delivery is the director it is intended for?

Problems that can occur with physical delivery methods include the loss, damage or delay of the board books, through accident or theft for example. This means that those who send out the board books need to have reliable feedback systems to ensure they know the papers are received. These feedback systems can be onerous and/or expensive, a signature indicating delivery of the board books needs to be checked for, and if sensitive papers are involved, the authenticity by comparison with a sample may be required.

Even if the board books are in the form of an encrypted electronic document distributed on physical media the same physical delivery problems exist. To overcome this it is possible to forward the individual papers or board books by email, but even in encrypted form, this puts information onto any number of intermediate servers for an indeterminate time period. No matter how good the encryption, in the end the information in one or more of the board papers can be extracted in a usable form, which may affect the viability of certain projects.

### OBJECT OF THE INVENTION

It is therefore an object of this invention to provide a method for preparing and distributing the board books or board paper which overcomes one or more of the deficiencies described above and/or provides a useful economical choice over present methods.

Any discussion of the prior art throughout the specification is not an admission that such prior art is widely known or forms part of the common general knowledge in the field.

The present invention provides a management system including a conversion system, a central system and one or more access points connected to the central system by a network; wherein said conversion system includes a scanning device and file conversion means configured to take a physical or electronic board paper and convert it to a digital document; the central system includes one or more accounts and one or more databases, such that the or each digital document is collated into one or more board books which is electronically stored in the or each database, the or each account is associated with a designated director who wishes to access the or each board book; said central system is configured to control access to the or each board book by the or each director.

Preferably the or each account is set up and administered by an administrator.

Preferably the network includes one or more of the following: the internet, a wide area network, a local area network and an intranet, either wireless or wired.

Preferably the or each access point runs client software, which in a highly preferred form is one or more script pushed out by the central system. Preferably said the or each script is configured to run on a web browser.

Preferably the format of the or each digital document is doc, rtf, xml, docx, ppt, pptx, xls, xlsx, doc, txt, pdf, tif, bmp, gif and jpg.

Preferably the or each director and/or the administrator can engage in two way communication regarding the or each board book or board paper.

The invention also provides a method for preparing and distributing a board paper that includes the following steps in order:
A. receiving one or more individual board papers;
B. converting each board paper into a digital document;
C. collating each of the digital documents into a board book and loading this into one or more databases stored on a central system;
D. an administrator sets up one or more account, and/or sets up one or more existing account, to access the or each database containing the board book;
E. the administrator advises each director that the board book is available;
F. the administrator administers the central system.

Preferably in step F the administrator carries out one or more action selected from the list consisting of: forwards a question from a director to an originator of a board paper for comment, posts a response from a director or an originator, amends access rights of any account, creates and administers the accounts, encrypts the board papers or board books and uploads updates to the client or server software.

### DESCRIPTION OF THE DRAWINGS

By way of example only a preferred embodiment of the present invention will now be described in detail with reference to the accompanying drawings in which:

FIG. 1 is a diagrammatic view of the system that implements the method

FIG. 2 is a flowchart of the method;

FIG. 3 is a diagrammatic view of the system with more than one board book and more than one board of directors.

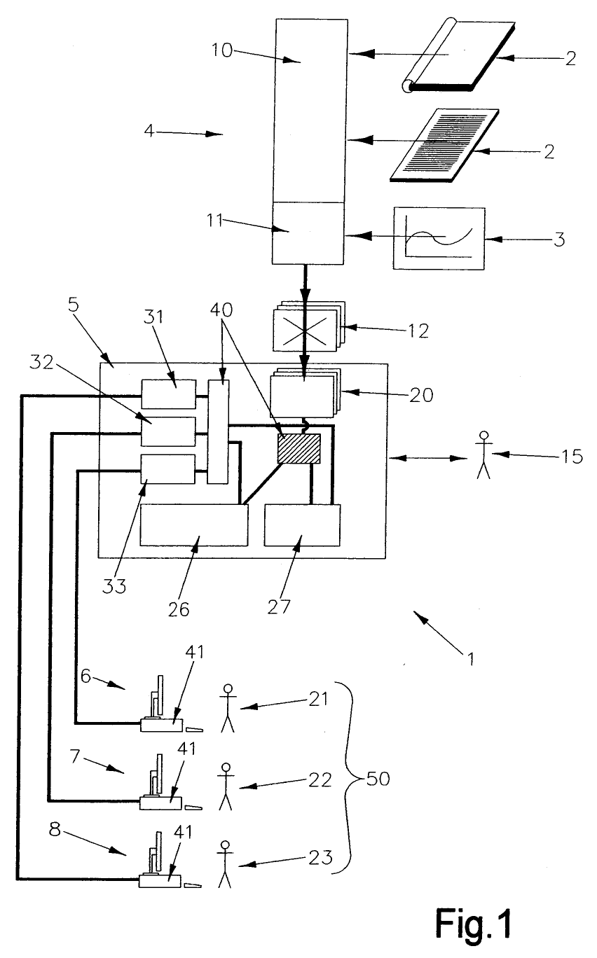

Referring to FIG. 1 a management system (1) for preparing and distributing board papers (2,3) including a conversion system (4), a central system (5) and one or more access points (6,7,8) is shown.

The conversion system (4) is configured to convert, where necessary, the board paper (2,3) into an acceptable file format for further processing in the central system (5). Acceptable formats include for example doc, rtf, xml, docx, ppt, pptx, xls, xlsx, doc, txt, pdf, tif, bmp, gif and jpg. The conversion system (4) includes a scanning device (10) and a file conversion means (11). The scanning device (10) takes each physical board paper (2), for example a printed paper copy, and converts it into a digital document (12). The file conversion means (11) is software or a software sub routine that takes each electronic board paper (3) and converts it to a digital document (12) in an acceptable file format. The digital documents (12) are then transmitted to the central system (5) for storage and further processing.

An administrator (15) of the central system (5), collates more than one of the digital documents (12) into a board book (20). The board book (20) being a collection of digitized board papers (2,3) for consideration by a board of directors (21,22,23) by a certain date. The board book (20) is stored by the central system (5) in one or more databases (26,27), for example a first database may store the text and a second database may store graphical information such as pictures, videos, graphs and the like related to the board book.

Each director (21,22,23) can access the central system (12) by logging onto an account (31,32,33) on the central system (12). Each director logs onto their account (31,32,33) using their access point (6,7,8) which is a computer, mobile phone, personal digital assistant (PDA) or similar electronic device. Each of the access points (6,7,8) is connected to the central system (12) by one or more of the following: the internet, local or wide area network, intranet or similar network of devices. Each account (31,32,33) requires one or more of the following before the director (21,22,23) is allowed access: a correct password, exchange of a required token, the presence of a dongle/smart card the entry of a correct biometric measurement.

The central system is most likely to be one or more servers remote from the or each director (21,22,23) but connected to a network, such as the internet, an intranet, local network or wide area network. The central system (12) stores, controls access and runs server software (40) to allow the directors (21,22,23) to access to each board book (20), for which they have clearance to see, using client software (41) on their access point (6,7,8). The client software (41) may be proprietary software running on the access point (6,7,8) or a script running on/in a standard web browser.

If the client software (41) is script based then the server software (40) can distribute this each time the director's (21,22,23) account (31,32,33) is accessed. This means that the client software (41) can rapidly incorporate any security or bug fixes and/or additional features requested. The disadvantage with the script based system is that it can have heavy central system (12) overheads associated with it. For this reason the client software could be installed on the access point (6,7,8) and take over some of the processing, thus reduce the load on the central system (12).

The client software allows the or each director to ask questions regarding the or each board book (20) or digital document (12), with the answers being made available via the server software (40).

In other words each director (6,7,8) runs client software (41) on their access point (6,7,8) that is set up to access an account (31,32,33) on the central system (12) running the server software (40), which is administered by the administrator (15). Access to that account (31,32,33) requires one or more security checks are passed, and there maybe different levels of access/control afforded to different accounts (31,32,33). Each director (21,22,23), via their account (6,7,8), has access to one or more databases (26,27) each containing one or more board books (20).

The director (21,22,23) can read the board books (20) for which they have clearance, and if necessary ask questions about each of these.

The or each account (31,32,33) or board book (20) may be encrypted, with the encryption and data security being managed by the administrator (15).

If web browser access is to be allowed for, then the client software (41) is one or more scripts pushed out by the central system (5) running on a web browser of known type. In this case the client software (41) is not necessarily installed on the access point (6,7,8) but instead runs on/in a web browser when connected to the central system (5). Advantages of a scripting approach include quick updating to avoid security holes identified, ability to customize interface and functionality for specific users without a recompiling/distribution of the client software (41); the ability to separate different users/user types by port/protocol or encryption level pushed out from the central system (5).

If the client software (41) is proprietary and installed on the or each access point (6,7,8) then some of the management system (1) load can be transferred to the access point (6,7,8) and the central system load (12) reduced. In addition the encryption can be built into the client and server software (40,41) improving the level of security. In addition the security afforded by a standard web browser may be insufficient to meet the required security

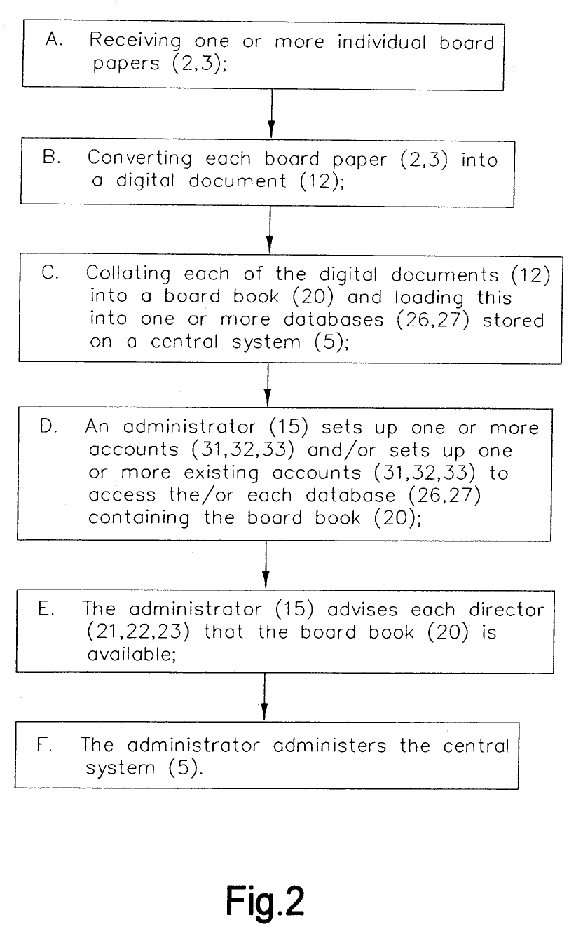

Referring to FIG. 2 the preferred method of preparing a board book (20) from one or more board papers (2,3) and providing access to this board book (20) for one or more director (21,22,23) on a board of directors (50) is shown.

The preferred method includes the following steps, in order:
A. receiving one or more individual board papers (2,3);
B. converting, each board paper (2,3) into a digital document (12);
C. collating each of the digital documents (12) into a board book (20) and loading this into one or more databases (26,27) stored on a central system (5);
D. an administrator (15) sets up one or more account (31,32,33), and/or sets up one or more existing account (31,32,33), to access the or each database (26,27) containing the board book (20);
E. the administrator (15) advises each director (21,22,23) that the board book (20) is available;
F. the administrator administers the central system (5).

Step A involves the administrator (15) receiving one or more board papers (2,3) in a variety of physical and electronic formats for consideration by a specific board of directors (21,22,23).

Step B involves converting any of the board papers (2,3) not in an acceptable format into a digital document (12) in an acceptable electronic format. This conversion may involve scanning, using a document scanner of known type, a physical original and converting this to editable or non-editable electronic file. The conversion may also require the conversion of a document in one electronic format to an acceptable electronic format.

Step C involves the collation of one or more digital document (12) into a single board book (20). This board book (20) is then stored in one or more databases (26,27) on the central system (5). If there is more than one database (26,27) then the graphical elements of the board book (20) can be stored in one and the text in the other.

In step D the administrator (15) allows certain accounts (31,32,33) access to the board book (20), these accounts (31,32,33) allow each director (21,22,23) access to the board book (20). Each account (31,32,33) may be an existing account (31,32,33) or a new account (31,32,33). To access their account (31,32,33) each director (21,22,23) may have to enter a password, install a smart card, transmit an authorization code/file be connected to a specific network or a combination of these.

In step E each director (21,22,23) is advised by the administrator (15) that the board book (20) is ready for review. Each director (21,22,23) can then access the board book (20) and review each board paper (2,3).

In step F the administrator carries out, for example only, one or more of the following: forwards a question from a director to the originator of the board paper (2,3) for comment, and posts the response, amends access rights of any accounts (31,32,33), creates and administers the accounts (31,32,33), uploads updates to the client or server software (40,41) and similar tasks.

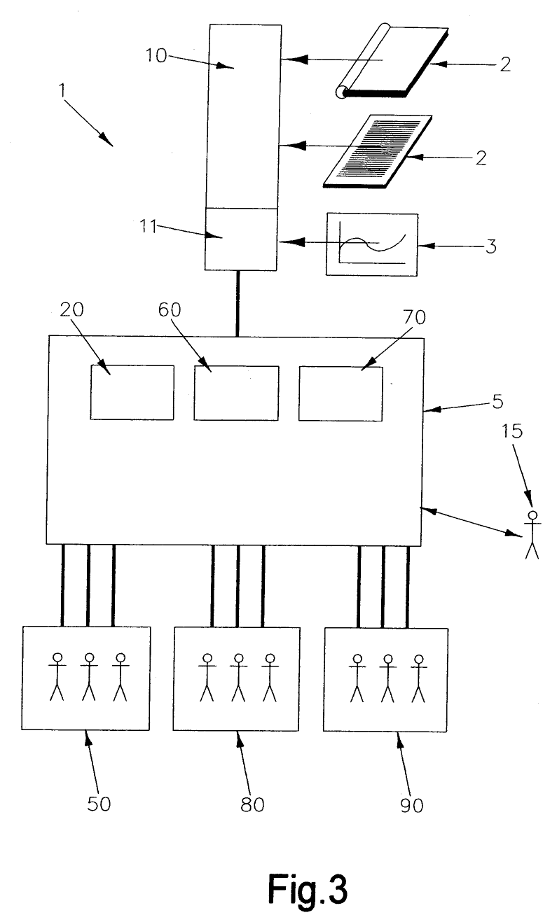

A further embodiment is shown in FIG. 3, in this embodiment the central system (5) manages a multitude of board books (20,60,70) for access by more than one board of directors (50,80,90). Noting that with the increase in the number of individual directors (21,22,23) sitting on more than one board (20,60,70) a single account (6,7,8) may have access to more than one board book (20,60,70).

Any discussion of the prior art throughout the specification is not an admission that such prior art is widely known or forms part of the common general knowledge in the field.

1. A management system including a conversion system, a central system and one or more access points connected to the central system by a network; wherein said conversion system includes a scanning device and file conversion means configured to take a physical or electronic board paper and convert it to a digital document; the central system includes one or more accounts and one or more databases, such that the or each digital document is collated into one or more board books which are electronically stored in the or each database, the or each account is associated with a designated director who wishes to access the or each board book; said central system is configured to control access to the or each board book by the or each director.

2. The management system as claimed in claim 1, characterized in that the or each account is set up and administered by an administrator.

3. The management system as claimed in claim 1 or claim 2, characterized in that the network includes one or more of the following: the internet, a wide area network, a local area network and an intranet, either wireless or wired.

4. The management system as claimed in claim 1, characterized in that the or each access point is independently selected from the list consisting of: a computer, a mobile phone and a personal digital assistant (PDA).

5. The management system as claimed in claim 1, characterized in that the or each access point runs client software.

6. The management system as claimed in claim 5, characterized in that the client software is one or more script pushed out by the central system.

7. The management system as claimed in claim 6, characterized in that the or each script is configured to run on a web browser.

8. The management system as claimed in claim 1, characterized in that the format of the or each digital document is selected from the group consisting of: doc, rtf, xml, docx, ppt, pptx, xls, xlsx, doc, txt, pdf, tif, bmp, gif and jpg.

9. The management system as claimed in claim 2, characterized in that the or each director and/or the administrator can engage in two way communication regarding the or each board book or board paper.

10. A method for preparing and distributing a board paper that includes the following steps in order:
A. receiving one or more individual board papers;
B. converting each board paper into a digital document;
C. collating each of the digital documents into a board book and loading this into one or more databases stored on a central system;
D. an administrator sets up one or more account, and/or sets up one or more existing account, to access the or each database containing the board book;
E. the administrator advises each director that the board book is available;
F. the administrator administers the central system.

11. The method of claim 10 characterized in that in step F the administrator carries out one or more action selected from the list consisting of: forwards a question from a director to an originator of a board paper for comment, posts a response from a director or an originator, amends access rights of any account, creates and administers the accounts, encrypts the board papers or board books and uploads updates to the client or server software.
